(19) United States
(12) Patent Application Publication
(10) Pub. No.: US 2013/0020952 A1
(43) Pub. Date: Jan. 24, 2013

(54) AC Direct Drive Organic Light Emitting Diode Assembly

(71) Applicants: Yu Pin Liao, Taichung City (TW); Chih Sheng Lin, Taichung City (TW)

(72) Inventors: Yu Pin Liao, Taichung City (TW); Chih Sheng Lin, Taichung City (TW)

(21) Appl. No.: 13/541,689

(22) Filed: Jul. 4, 2012

(30) Foreign Application Priority Data
Jul. 20, 2011 (TW) 100125557

(51) Int. Cl. H05B 37/02

(52) U.S. Cl. 315/192

(57) ABSTRACT

The present invention is related to AC direct drive organic light emitting diode assembly which comprises parallelly connected a positive duty OLED serial and a negative duty OLED serial receiving an AC voltage. A positive duty of the AC voltage actives the positive serial OLED to generates light output and a negative duty of the AC voltage lights on the negative serial OLED so that the present invention can be driven directly with AC power. The present invention provides a sparkless light output OLED assembly having a very low production cost and being very convenience to use.

### BACKGROUND OF THE INVENTION

1. Field of Invention

The present invention relates to an organic light emitting diode, particularly to an organic light emitting diode that is capable of being directly driven by AC power.

2. Description of the Related Art

Markets of environmental friendly electric products are increased dramatically in recent years since people aware of the sensational changes of weather of our planet. Take lighting technology as an example, light emitting diodes (LEDs) are fastly replacing conventional blubs and fluorescent lamps since LEDs are considered more environmental friendly and with higher efficiency of electronic power usage. Conventional LED is driven by a DC power source, thus a rectifier, a filter and a regulator are required when connecting he LED to an AC power source. To solve a cost issues from using the aforementioned electronic elements/circuits, an ACLED that is able to be directly connected to the AC power source is produced. The ACLED comprises a positive duty LED series and a negative duty LED series. The positive duty LED series comprises a forward bias direction and multiple LED units being serially connected. The negative duty LED series comprises a forward bias direction and multiple LED units being serially connected. The negative duty LED series is parallelly connected to the positive duty LED series and the forward bias direction of the negative duty LED series is reverse to the forward bias direction of the positive duty LED series. Thus, the ACLED can be directly connected to the AC power since the positive duty LED series and the negative duty LED series are alternatively activated respectively by a positive duty and a negative duty of an AC voltage from the AC power source.

Although the required electronic elements are reduced in use of the ACLED, but the ACLED is still not accepted in the market since an uncomfortable flicker existed during the use of the ACLED. The flicker of the ACLED is caused by difference between forward biases of the LED units in the negative duty LED series and the positive duty LED series. The difference of the forwards biases of the LED units can only be controlled in to 0.3 volts even using a same substrate.

The present invention provides an AC direct drive organic light emitting diode assembly with high brightness and without flicker problem to overcome shortcomings of a conventional ACLED.

### SUMMARY OF THE INVENTION

The primary objective of the present invention is to provide an AC direct drive organic light emitting diode assembly having high brightness light output and being flicker free.

The present invention applies two opposite duty serials, each serial comprises multiple high luminance organic light emitting diodes (OLED) that serially connected to each other. With the same driving power voltage requirement and equivalent capacitances thereof that regulating the input power, the OLED flicker problem is resolved.

The present invention accordingly provides an AC direct drive organic light emitting diode assembly that comprises a positive duty OLED serial and a negative duty OLED serial. The positive duty OLED serial and the negative duty OLED serial are parallelly connected to each other and receive an AC power input. The positive duty of an AC voltage activates the positive duty OLED serial to generate light, and the negative duty of the AC voltage activates the negative duty OLED serial to generate light.

As said above, each of the positive duty OLED serial and the negative duty OLED serial respectively comprises multiple high luminance OLEDs that serially connected to each other. Each of the OLEDs comprises a transparent substrate, a transparent electrode, an organic lighting structure, a cathode and a lid. The transparent electrode, the organic lighting structure and the cathode are orderly stack overlay between the substrate and the lid.

Moreover, the positive duty OLED serial and the negative duty OLED serial may further connected with resist elements respectively for receiving the AC power.

Otherwise, above mentioned organic lighting structure may consist of multiple organic lighting materials that emit light in different colors. Alternatively, the positive duty OLED serial and the negative duty OLED serial may comprise multiple OLEDs that emit light in different colors. Or, the positive duty OLED serials and the negative duty OLED serials respectively comprise OLEDs that emit light in the same color. Moreover, the positive duty OLED serials and the negative duty OLED serials respectively may comprises both of OLEDs that emit light in the same color and OLEDs that emit light in different colors.

Additionally, the positive duty OLED serial and the negative duty OLED serial connect switching units respectively. Each switching unit couples to a control unit that controls operation of the switching unit and accordingly turns the OLED serial on or off.

Particularly, the substrate and the lid of each OLED has a low reflection film and an anti-reflection film attached on outer surfaces of the substrate and the lid. The low reflection film may be an anti-glare film, a light scattering film or a light absorbing film. The anti-reflection film is an optical thin film structure having very low visible light reflection and may be interferometric film or polarized film.

Other objectives, advantages and novel features of the invention will become more apparent from the following detailed description when taken in conjunction with the accompanying drawings.

### BRIEF DESCRIPTION OF THE DRAWINGS

FIG. 1 is a first embodiment of an AC direct drive organic light emitting diode (OLED) assembly in accordance with the present invention;

FIG. 2 is a layer structure of an OLED of the AC direct drive OLED assembly in FIG. 1;

FIG. 3 is an equilibrium circuit of the AC direct drive OLED assembly in FIG. 1;

FIG. 4 is a second embodiment of the AC direct drive OLED assembly in accordance with the present invention;

FIG. 5A is a third embodiment of the AC direct drive OLED assembly in accordance with the present invention; and

FIG. 5B is a layout example of the AC direct drive OLED assembly in accordance with FIG. 5A.

### DETAILED DESCRIPTION OF THE INVENTION

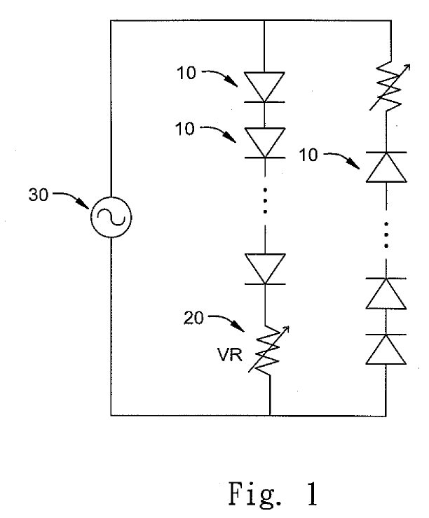

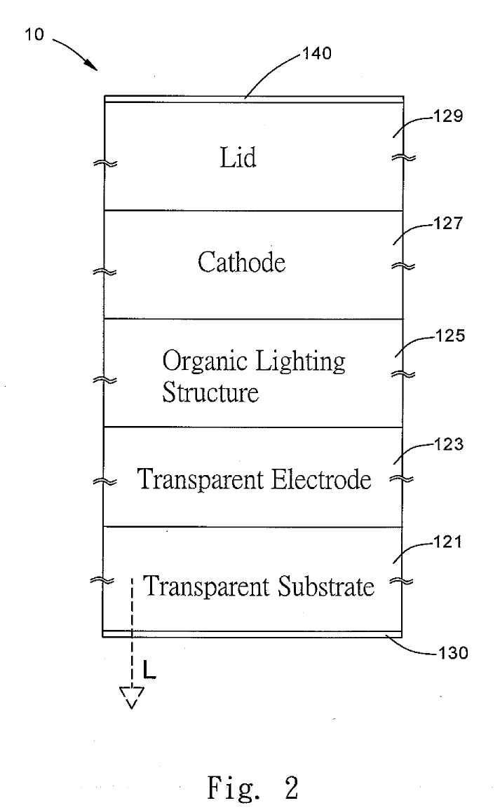

With reference to FIGS. 1 and 2, an AC direct drive organic light emitting diode (OLED) assembly in accordance with the present invention comprises multiple positive duty OLED serials and negative duty OLED serials that are parallelly connected to each other, and furthermore, multiple resist elements (20). An AC power (30) may be input the positive duty OLED serial and the negative duty OLED serial. When input the AC power, a positive duty of an AC voltage of the AC power (30) activates the positive duty OLED serial to generate light, and a negative duty of the AC voltage of the AC power (30) activates the negative duty OLED serial to generate light.

Each of the positive duty OLED serial and the negative duty OLED serial comprises multiple OLEDs (10) serially connected to each other. Each OLED (10) comprises a substrate (121), a transparent electrode (123), an organic lighting structure (125), a cathode (127) and a lid (129) and may have a low reflection film (140) and an anti-reflection film (130). The transparent electrode (123), the organic lighting structure (125) and the cathode (127) are orderly stack overlay between the substrate (121) and the lid (129). When an adequate electromotive force or voltage drop exists between the transparent electrode (123) and the cathode (127), the organic lighting structure (125) generates light (L).

The substrate (121) is transparent plate, may be glass or polymer made, and has an inner surface, an outer surface and an edge.

The OLEDs (10) are formed on the inner surface of the substrate (121) and each OLED (10) has a threshold voltage. The OLEDs (10) are grouped as a positive duty OLED serials and a negative duty OLED serials. The positive duty OLED serials have multiple serial connected OLEDs (10) and have a defined activation voltage. The activation voltage of the positive duty OLED serials is a sum of the threshold voltages of the OLEDs (10) thereof. The negative duty OLED serials have multiple serial connected OLEDs (10) and have a defined activation voltage being the sum of the threshold voltages of the OLEDs (10). The negative duty OLED serials are parallel connected reversely to the positive duty OLED serials and the positive duty OLED serials and the negative duty OLED serials are connected to an AC power (30) respectively. The AC power (30) provides a sinusoidal power to alternatively provide the activation voltages of the positive duty OLED serials and the negative duty OLED serials. Thus, an embodiment having parallelly connected positive duty OLED serials and negative duty OLED serials can be connected to the AC power (30) and directly driven.

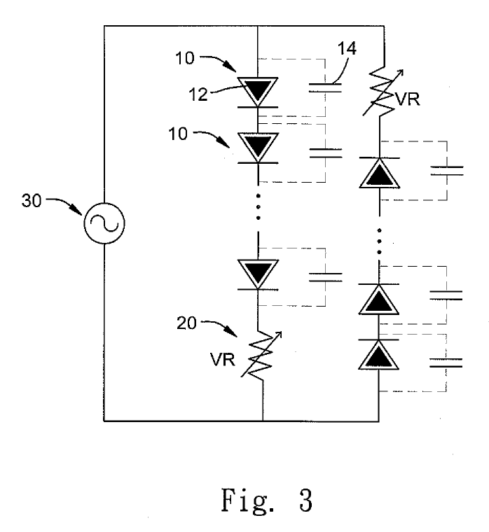

With reference to FIG. 3, each OLED (10) is equivalently comprises an ideal optical diode (12) and an ideal capacitor (14) being parallelly connected to the ideal optical diode (12). The ideal capacitor (14) is naturally existed in the OLED (10) and is able to stable the inputted sinusoidal power so that the light (L) generated from the first embodiment may be very stable and flicker free compared to prior art since

The transparent electrode (123) is formed on the inner surface of the substrate (121) and is metal oxide such like Indium Tin Oxide (ITO), Zinc Oxide and the like. The transparent electrodes (123) of the OLEDs (10) may be continuously connected to each other and form a sheet-like layer being deposited onto the inner surface of the substrate (121).

The organic lighting structure (125) may be translucent, is formed on the transparent electrode (123) with using a deposition process and is a laminated film structure having an emissive electroluminescent layer. The emissive electroluminescent layer is a film of organic compounds which emit light (L) in response to an electric current being provided. The light (L) emitted from the organic lighting structure (125) can be a desired color with selecting suitable materials of emissive electroluminescent layers and film structure, the desired structure may be blue (B), red (R), green (G) and white.

The cathode (127) is electronically conductive and is formed on the organic lighting structure (125) with the vapor deposition process. The cathode (127) is a metal film or a transparent conductive oxide (TCO) film that has a work function matched to the organic lighting structure (125). The cathode (127) and the transparent electrode (123) provide a voltage drop and the electric current to the organic lighting structure (125) to emit the light (L). The cathode (127) may further be a TCO film with integrating anti-reflection structure to reduce light reflection from the organic lighting structure (125) and improve the visibility of the OLED (10).

The lid (129) is moisture proved and is specific gases resisted, may be transparent, has a lid edge, an inner surface, an outer surface and an optional moisture absorbent. The lid (129) is placed above and lids the OLEDs (10). The lid edge of the lid (129) is corresponding to and is sealed with the edge of the substrate (121) to isolate the OLEDs (10) from environment moisture and gases. The moisture absorbent may be translucent or transparent, is mounted or formed on the inner surface of the lid (129) and is used to absorb the leaked environment moisture and gases so as to increase lifetime of the OLEDs (10).

The low reflection film (140) is transparent with very low light reflection ratio, is mounted on the outer surface of the substrate (121) and may be an anti-glare film, a light scattering film or a light absorbing film. The low reflection film (140) reduces environment light reflection so as to increase contract ratio compared to the light (L) output from each OLED (10).

The anti-reflection film (130) is an optical thin film structure having very low visible light reflection and may be formed on the outer surface or inner surface of the lid (129). When environment light inserted through the substrate (121), the OLED (10), the cathode (127) and the lid (129), light reflection from the lid (129) back to the substrate (121) is partially decreased by the transparent or translucent lid (129) and the anti-reflection film (130). Thus, since the reflection of the environment light was reduced by the low reflection film (140), the anti-reflection film (130) and the cathode (127) respectively, a contrast ratio of the OLED (10) was improved accordingly.

The resist elements (20) are serially connected to the positive duty OLED serials and negative duty OLED serials respectively. The resist elements (20) may limit and regulate the input current flow to prevent the OLEDs (10) from being damaged by a current surge. The styles of the resist elements (20) are not limited, and may be individual electronic components that independent from the OLEDs (10) and may be a part of the transparent electrode (123) that formed by Photolithigraphy process. In the case of being part of the transparent electrode (123), practically, the resist elements (20) may be wire wound resistors. Accordingly, it is available to adjust the resistance by changing amount of the wire wound resistors.

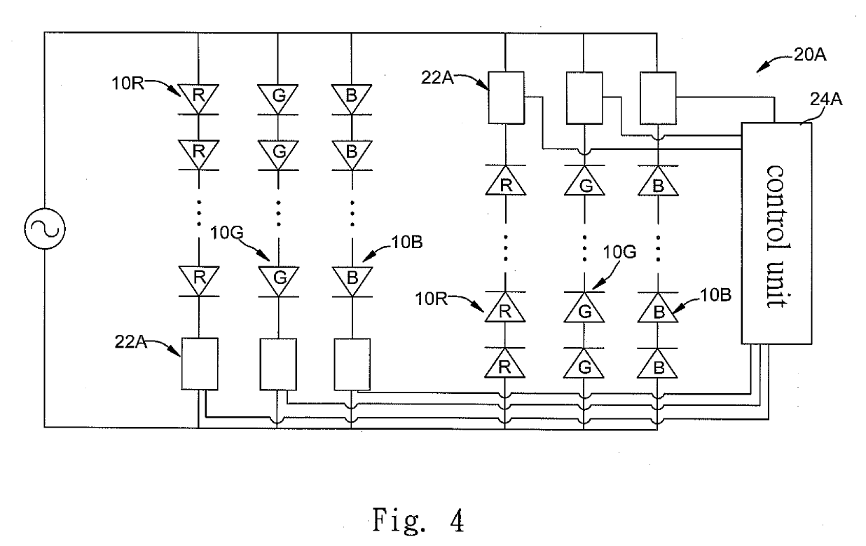

With reference to FIG. 4, with a specific arrangement of the OLEDs (10R)(10G)(10B) that generates respectively Red (R), Green (G) and Blue (B) light in the positive duty OLED serial or the negative duty OLED serial, a predetermined color effect may be presented. In present embodiment, the AC direct drive organic light emitting diode (OLED) assembly in accordance with the present invention comprises three positive duty OLED serials and three negative duty OLED serials that are parallelly connected to each other, respectively. The three positive duty OLED serials differently includes multiple OLEDs (10R) serially connected to each other, multiple OLEDs (10G) serially connected to each other, and multiple OLEDs (10B) serially connected to each other. Similarly, the three negative duty OLED serials differently includes multiple OLEDs (10R) serially connected to each other, multiple OLEDs (10G) serially connected to each other, and multiple OLEDs (10B) serially connected to each other. In such an arrangement, when an AC power is input, the positive duty OLED serials and the negative duty OLED serials sequentially activated and with mixture of the Red, Green and Blue light to generate white light. In order to generate determined colored light, an adjustment module (20A) is implemented in present embodiment. The adjustment module (20A) comprises multiple switching units (22A) and a control unit (24A). Each switching unit (22A) is connected between the control unit (24A) and one corresponding positive duty OLED serial or negative duty OLED serial. The switching unit (22A) is controllable by the control unit (24A) to turn on or off, thereby controls actions of said positive duty OLED serial or negative duty OLED serial, so as to make color effect presented controllable. An example is illustrated in FIG. 4, in which with turning off the two switching unit (22A) connecting to the OLEDs (10G) with green organic lighting structure (125), may produce a purple light effect. Additionally, in case of more than three positive duty OLED serial and/or negative duty OLED serial that parallelly connected to each other, operation of the switching unit (22A) may, not only produce adjustable light color effect, but also make it possible to change luminance thereof.

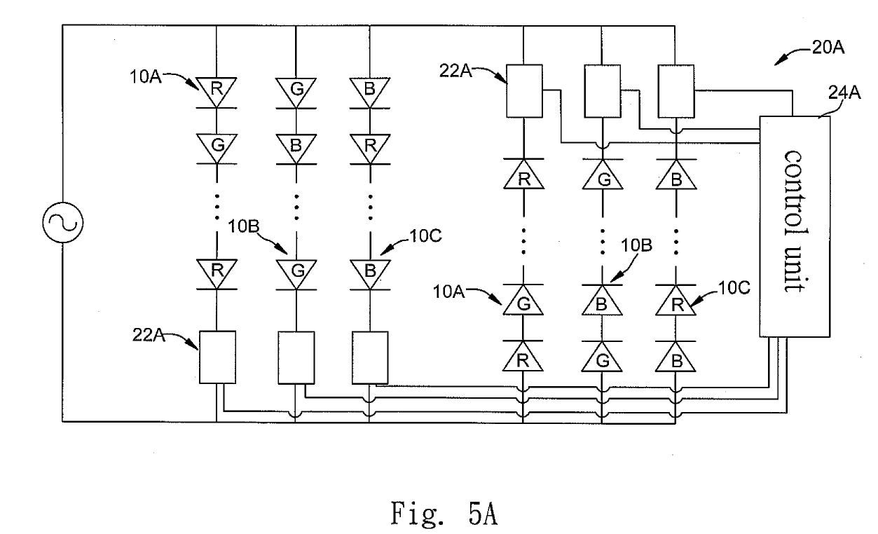

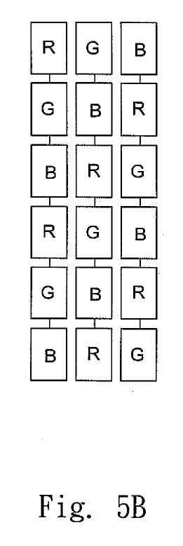

Furthermore, with reference to FIGS. 5A and B, each positive/negative duty OLED serial (10A)(10B)(10C) may consist of multiple red light OLEDs (10R), multiple green light OLEDs (10G) and multiple blue light OLEDs (10B) that connected to each other in a specific arrangement. With such, the light emitted from the OLEDs can evenly mix up to generate white light, plus the luminance is adjustable.

Accordingly, with reference to previous illustrated embodiment, it is known that present invention provides advantages as follow:

1. Being able to be directly driven by AC, thus resolves existing problems in the prior art.

2. Through different structural overlays or circuit arrangements, light of different colors is evenly produced.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. An AC direct drive organic light emitting diode (OLED) assembly comprising:
multiple positive duty OLED serials and multiple negative duty OLED serials that being parallelly connected to each other for an input of AC power;
wherein a positive duty of an AC voltage of the AC power activates the positive duty OLED serial to generate light, and a negative duty of the AC voltage activates the negative duty OLED serial to generate light;
wherein each of the positive duty OLED serials and the negative duty OLED serials comprises multiple OLEDs serially connected to each other; and
wherein each OLED comprises a transparent electrode, an organic lighting structure and a cathode orderly stack overlay between a substrate and a lid thereof.

2. The AC direct drive organic light emitting diode (OLED) assembly as claimed in claim 1, further comprising multiple resist elements being serially connected to the positive duty OLED serials and negative duty OLED serials, respectively.

3. The AC direct drive organic light emitting diode (OLED) assembly as claimed in claim 2, wherein the organic lighting structure of each OLED is consist of multiple organic lighting materials that emit light in different colors.

4. The AC direct drive organic light emitting diode (OLED) assembly as claimed in claim 3, wherein the positive duty OLED serial and the negative duty OLED serial comprise multiple OLEDs that emit light in different colors.

5. The AC direct drive organic light emitting diode (OLED) assembly as claimed in claim 3, wherein the positive duty OLED serials and the negative duty OLED serials respectively comprises OLEDs that emit light in the same color.

6. The AC direct drive organic light emitting diode (OLED) assembly as claimed in claim 3, wherein the positive duty OLED serials and the negative duty OLED serials respectively comprise both of OLEDs that emit light in the same color and OLEDs that emit light in different colors.

7. The AC direct drive organic light emitting diode (OLED) assembly as claimed in claim 5, further comprise an adjustment module comprising multiple switching units and a control unit;
wherein each switching unit is connected between the control unit and one corresponding positive duty OLED serial or negative duty OLED serial, the switching unit are controllable by the control unit to turn on or off, thereby controls actions of said positive duty OLED serial or negative duty OLED serial, so as to make color effect presented controllable.

8. The AC direct drive organic light emitting diode (OLED) assembly as claimed in claim 6, further comprise an adjustment module comprising multiple switching units and a control unit;
wherein each switching unit is connected between the control unit and one corresponding positive duty OLED serial or negative duty OLED serial, the switching unit are controllable by the control unit to turn on or off, thereby controls actions of said positive duty OLED serial or negative duty OLED serial, so as to make color effect presented controllable.

9. The AC direct drive organic light emitting diode (OLED) assembly as claimed in claim 7, wherein the substrate and the lid of each OLED further has a low reflection film and an anti-reflection film attached on outer surfaces of the substrate and the lid;
wherein the low reflection film is an anti-glare film, a light scattering film or a light absorbing film; and the anti-reflection film is an interferometric film or polarized film.

10. The AC direct drive organic light emitting diode (OLED) assembly as claimed in claim 8, wherein the substrate and the lid of each OLED further has a low reflection film and an anti-reflection film attached on outer surfaces of the substrate and the lid;
wherein the low reflection film is an anti-glare film, a light scattering film or a light absorbing film; and the anti-reflection film is an interferometric film or polarized film.
